(19) United States
(12) Patent Application Publication
(10) Pub. No.: US 2009/0242546 A1
(43) Pub. Date: Oct. 1, 2009

(54) COOKING APPARATUS WITH THERMALLY SHIELDED TEMPERATURE SENSOR

(76) Inventors: Christian M. Yungbluth, Charlotte, NC (US); Bektas C. Gulkanat, Charlotte, NC (US)

Correspondence Address: THOMPSON HINE LLP;Intellectual Property Group, P.O Box 8801, DAYTON, OH, 45401-8801, US

(21) Appl. No.: 12/406,401

(22) Filed: Mar. 18, 2009

Related U.S. Application Data
(60) Provisional application No. 61/039,631, filed on Mar. 26, 2008.

(51) Int. Cl. H05B 3/68; G06F 19/00

(52) U.S. Cl. 219/448.11; 700/97

(57) ABSTRACT

A cooking apparatus includes a heating element and a cooking plate arranged and configured to be heated by the heating element, the cooking plate having a first surface facing the heating element and a cooking surface opposite the first surface. A thermostat is located proximate the first surface and associated with a heating element control. An insulating heat shield arrangement partially surrounds the thermostat and shields a shielded portion of the first surface adjacent the thermostat from direct heating by the heating element. The insulating heat shield arrangement is configured to provide a thermal resistance Rₕ through the cooking plate between the shielded portion of the first surface at the thermostat and a directly heated portion of the first surface outside the shielded portion. The cooking plate is configured such that a thermal resistance R_{c} through the cooking plate is provided between the shielded portion of the first surface at the thermostat and the cooking surface. The insulating heat shield arrangement is configured such that thermal resistance Rₕ is no less than thermal resistance R_{c}.

### TECHNICAL FIELD

This application relates generally to a cooking apparatus and more particularly to a cooking apparatus with improved thermal shielding for bottom mounted thermostatic devices.

### BACKGROUND

Cooking devices, such as griddle apparatus, are frequently used in commercial settings for cooking various types of food, such as hamburgers. The griddle apparatus typically includes a thermostat control where an operator can set a cooking temperature. The thermostat control may include a bottom mounted thermostat probe, bulb or other device that is located beneath the cooking surface, next to a surface being heated by burners. The thermostat control should optimally indicate the temperature at the cooking surface in order to avoid causing the heating element to deactivate before the cooking surface reaches the set temperature.

### SUMMARY

In an aspect, a cooking apparatus includes a housing, a heating element located in the housing and a cooking plate arranged and configured to be heated by the heating element, the cooking plate having a first surface facing the heating element and a cooking surface opposite the first surface. A thermostat is located proximate the first surface and associated with a heating element control. An insulating heat shield arrangement partially surrounds the thermostat and shields a shielded portion of the first surface adjacent the thermostat from direct heating by the heating element. The insulating heat shield arrangement is configured to provide a thermal resistance Rₕ through the cooking plate between the shielded portion of the first surface at the thermostat and a directly heated portion of the first surface outside the shielded portion. The cooking plate is configured such that a thermal resistance R_{c} through the cooking plate is provided between the shielded portion of the first surface at the thermostat and the cooking surface. The insulating heat shield arrangement is configured such that thermal resistance Rₕ is no less than thermal resistance R_{c}.

In another embodiment, where the thermal resistance per unit length through the plate material is constant regardless of direction, a lateral distance between the bulb location and a lateral edge of the heat shield is selected to be no less than that of a vertical distance between the lower surface and cooking surface of the plate. In one implementation, the lateral distance is selected slightly greater than (i.e., between 10 and 30% greater than) the vertical distance.

In some implementations, suitable function may be achieved where the thermal resistance Rₕ is at least 90%, but no more than 135% of the thermal resistance R_{c} (e.g., between 90% and 125% or between 95% and 120%).

In another aspect, a method of designing a cooking plate configuration for a cooking apparatus involves: determining a location for a thermostat element along a heated surface of the cooking plate; determining a through the plate thermal resistance R_{c} between a cooking surface of the cooking plate and the defined location of the thermostat element; determining a lateral distance from the thermostat element that results in a lateral through the plate thermal resistance Rₕ that is at least about 90% of the through the plate thermal resistance R_{c}; and defining a heat shield configuration that corresponds to the determined lateral distance.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a diagrammatic, section view of an embodiment of a thermostat control for a griddle apparatus;

FIG. 2 is another diagrammatic, section view of an embodiment of a prior art thermostat control for a griddle apparatus;

FIG. 3 is a diagrammatic, section view of an embodiment of a thermostat control for a griddle apparatus according to the present application;

FIG. 4 is a heating control plot comparing the configurations of FIG. 2 and FIG. 3;

FIG. 5 is another diagrammatic, section view of an embodiment of a thermostat control for a griddle apparatus according to the present application;

FIG. 6 is another diagrammatic, section view of an embodiment of a thermostat control for a griddle apparatus according to the present application;

FIG. 7 is another diagrammatic, section view of an embodiment of a thermostat control for a griddle apparatus according to the present application;

FIG. 8 is another diagrammatic, section view of an embodiment of a thermostat control for a griddle apparatus according to the present application;

FIGS. 9A and 9B depict an exemplary griddle apparatus.

### DETAILED DESCRIPTION

A unique shielding arrangement is provided for bottom mounted thermostat controls in a griddle application, or other cooking device application, that provides improved temperature control.

Referring to FIG. 1, an exemplary bottom mounted construction of a hydraulic bulb thermostat control (generally referred to as element 10) is shown for a griddle apparatus. The griddle apparatus includes a griddle plate 12 having an upper cooking surface 14 and a lower surface 16 that is opposite the cooking surface. While the griddle plate 12 may be a variety of thicknesses, in some embodiments, the thickness of the griddle plate may be between about 0.5 and one inch and formed of any suitable material such as carbon steel. Where the griddle plate is of a type that is grooved, the overall plate thickness dimension may be determined as the average plate thickness. The lower surface 16 faces a heating element (represented by elements 15) that is used to heat the griddle plate 12 to a desired temperature. The heating element may be a gas burner or an electrical element.

The thermostat control 10 includes a thermostat bulb 18 in contact with the lower surface 16 at a contact location C₁ and inner and outer shields 20 and 22, respectively, partially surrounding the thermostat bulb. The outer shield 22 shields a shielded portion 24 of the lower surface 16 defined between boundaries B₁ and B₂ from radiation, convection and/or conduction heating by the heating element. An insulated space 25 is located between the inner and outer shields 20 and 24. Any suitable insulation 27 may be located in the insulated space, such as rigid pumous materials, fabric-type insulation or others. While any suitable geometry may be used for the shields 20 and 22, V-shaped shields are shown.

The bottom mounted thermostat provides an indication of (or approximates) temperature at the cooking surface 14 despite its position at the bottom of the griddle plate 12. The thermostat bulb 18 senses temperature at its contact point C₁ with the lower surface 16, and is affected by lateral thermal resistance from a directly heated surface portion 26 to the thermostat bulb and vertical thermal resistance from the heat source to the cooking surface (which is equal to the thickness of the of the griddle plate assuming a griddle plate of substantially constant thickness and uniform material).

In order to provide an indication of temperature at the cooking surface 14 despite its position at the bottom of the griddle plate 12, an important parameter for the bottom mounted thermostat is the relative thermal resistance between it and the cooking surface 14—that for which the thermostat temperature is set—and the directly heated surface 26—that surface outside the shielded portion 24 which is heated directly by the heating element. In the illustrated embodiment, the shortest distance D₁ between the thermostat bulb 18 and the heated surface 26 is along a horizontal line from the contact location C₁ to the boundary B₁ (B₁ and B₂ may be equidistant from C₁). The shortest distance D₂ between the thermostat bulb 18 and the cooking surface 14 is typically a straight vertical line from the contact location C₁ to the cooking surface. With the griddle plate medium having a constant thermal resistance/per unit length (regardless of direction), distances D₁ and D₂ are proportional to the thermal resistances. Where the griddle plate does not have constant thermal resistance/per unit length (e.g. in the case of a griddle plate formed by sandwiching two or more plate materials together), the distances D1 and D2 may not be proportional to the thermal resistance, in which case a more considered analysis of the thermal resistance may need to be taken, particularly in the vertical direction.

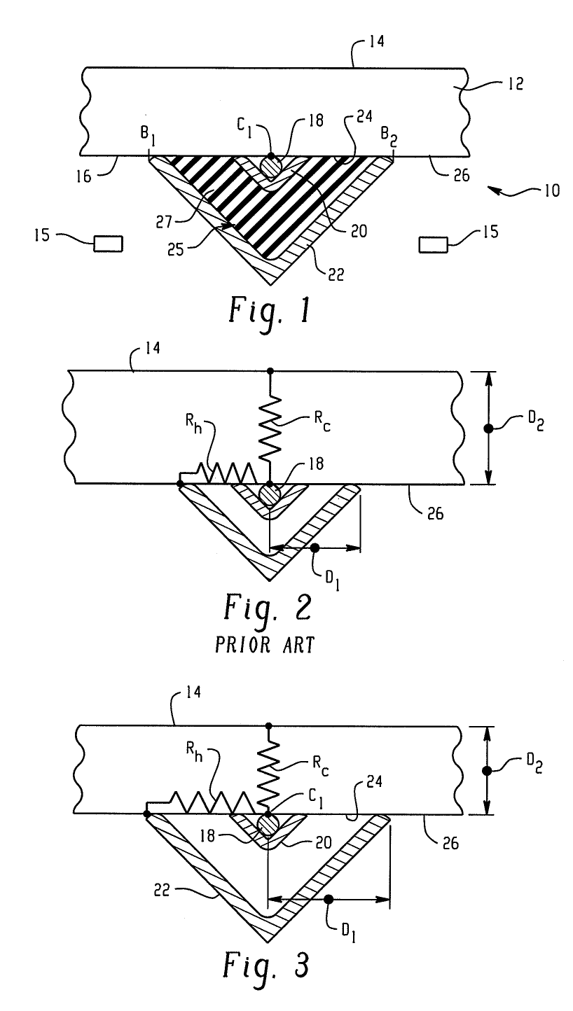

FIG. 2 shows a “small shield” configuration (without the insulation material shown) of the type used in prior art griddles. Assuming a uniform plate material in this example, the “small shield” results in a difference in lateral thermal resistance (Rₕ) between the thermostat bulb 18 and heated surface portion 26 as compared to the vertical thermal resistance (R_{c}) between the thermostat bulb and the cooking surface 14, whereby Rₕ is less than R_{c}. In this instance, the thermostat bulb 18 will typically sense and react to the temperature of the heated surface portion 26 before the cooking surface 14 achieves the set temperature. While the system will eventually reach steady state around the set temperature, optimal system performance can be impacted when Rₕ<R_{c}.

Referring to FIG. 3, an exemplary “large shield” configuration of the invention is shown (assumed uniform plate material), which moves the directly heated surface portion 26 a greater distance D₁ from the thermostat bulb 18 such that it at least equals the distance D₂ from the cooking surface 14 to the thermostat bulb (or from the heated surface to the cooking surface) such that the thermal resistance Rₕ at least equals or is greater than the thermal resistance R_{c}. In this embodiment, a span S (D₁ times two) of the outer shield 22 is selected to increase the distance D₁. For Rₕ>R_{c}, no significant difference between performance curves is expected. Since exact border positions between the heated surface 26 and shielded portion 24 can be difficult to pinpoint precisely, in some cases it may be desirable, though not required, to select a nominal distance of approximately ⅛ inch (or other suitable dimension) greater than the distance D₂ to ensure that the desired boundaries are exceed, but not excessively so, and to account for possible perturbations in the manufacturing process. For the large shield configuration of FIG. 3, the distance D₁ to the heated surface 26 from the contact point C₁ is greater than the distance D₂ from the cooking surface 14, thus a temperature change at the cooking surface due to application of heat to surface 26 will occur more rapidly than a temperature change at the bulb location C1. While not shown, insulation material would be located between the shield 22 and the shield 20 (e.g., per FIG. 1).

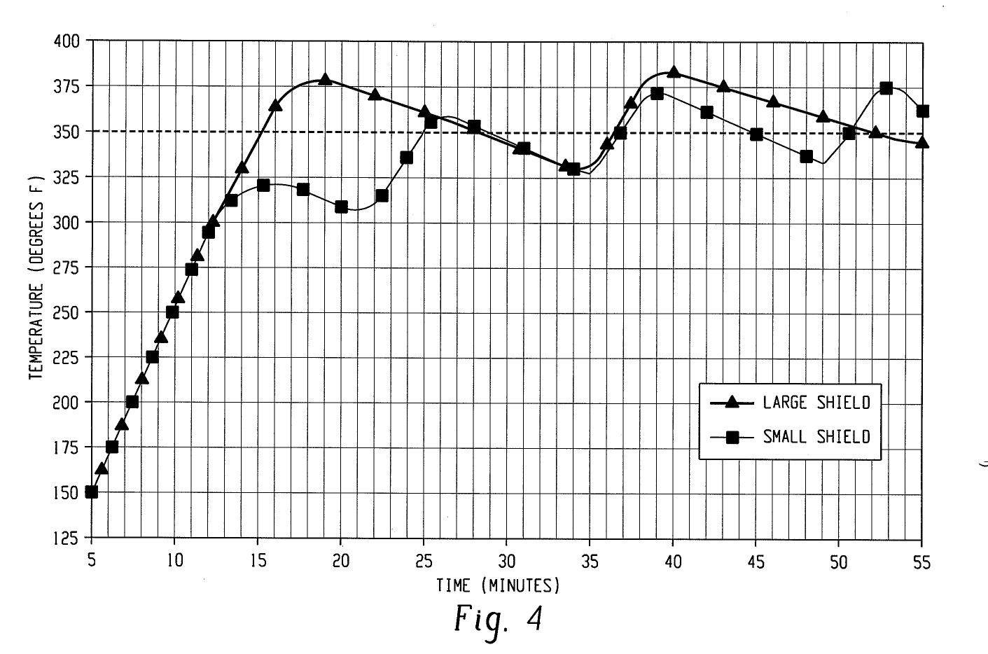

FIG. 4 shows data illustrating the effect of the smaller versus larger shield configurations. The data of FIG. 4 reflects a comparative test using identical thermostats on the same griddle plate, each set to 350° F., but in one case shielded using a prior art “small shield” approach and in the other case using the inventive “large shield” approach. The thickness of the griddle plate, which is of a uniform material, is 0.875 inch thick, and the Rₕ distances for the small and large shields are 0.71 inch and 1.07 inch, respectively. The griddle plate being heated using a natural gas burner.

As can be seen by FIG. 4, when Rₕ is smaller than R_{c}, system response is driven by Rₕ and the heating element is turned off before the cooking surface achieves the set temperature. When Rₕ is greater than R_{c}, the cooking surface will achieve set temperature more rapidly and cycle normally. When the cooking surface is loaded (e.g., cooled via contact with cold food product), this response curve will be repeated continuously. Since accurate temperature response to product loading (recovery) is important to this class of cooking device, the above-described large shield approach can significantly improve recovery performance.

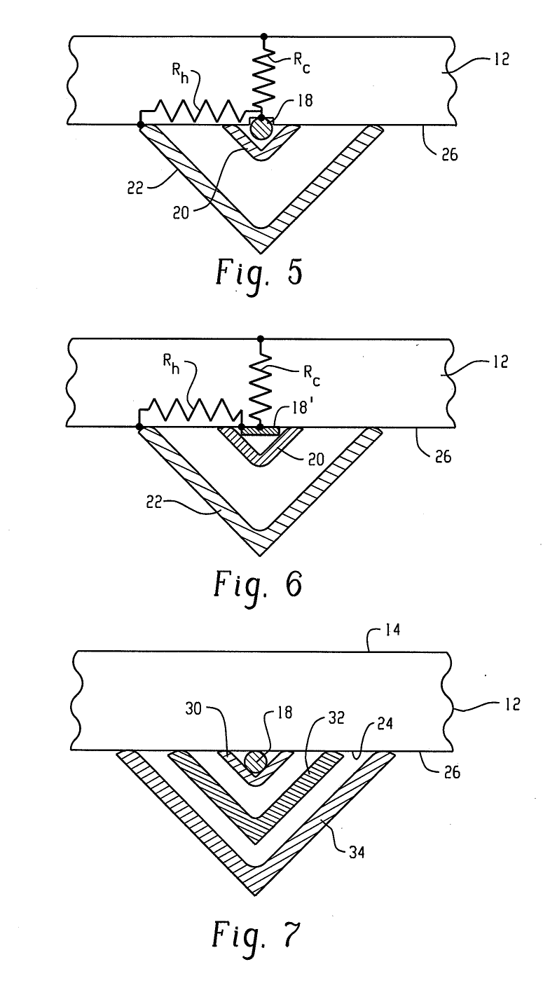

It is recognized that alternative probe mount configurations are possible, such as providing a slight upward recess along the bottom surface, and placing the thermostat shield in the recess (e.g., per FIG. 5), in which case the thermal resistance measurement Rₕ may actually be taken at a slight angle relative to the main plane of the lower surface and/or may involve evaluation of a non-linear resistance path through the plate, as shown.

Although a thermostat bulb having a single point or line of contact with the griddle plate is primarily shown, it is recognized that alternative configurations are possible. For example, a thermostat 18′ having a generally flat configuration, such as that shown in FIG. 6, would have a plane of contact with the lower surface of the griddle plate. In such an arrangement, the appropriate location for measurement of the lateral thermal resistance Rₕ would be at the edge of the plane of contact as shown. While not shown, insulation material would be located between the shield 22 and the shield 20.

FIG. 7 shows an alternate shielding configuration utilizing three shields 30, 32 and 34. In this configuration, the representative locations for measuring Rₕ and R_{c} are shown. Insulation would be located between shields 30 and 32. The space between shields 32 and 34 could include insulation, or could simply be an air gap.

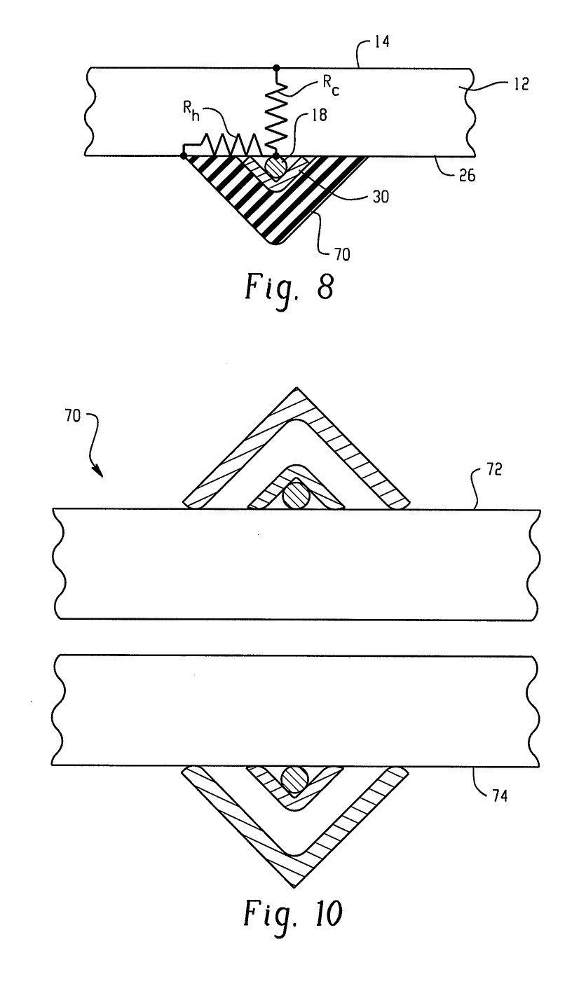

Referring to FIG. 8, alternative arrangement having only a single shield 30 is provided, with thick insulation material 70 surrounding the shield. In this arrangement, the reference for measuring thermal resistance Rₕ is to the edge of the insulation material itself.

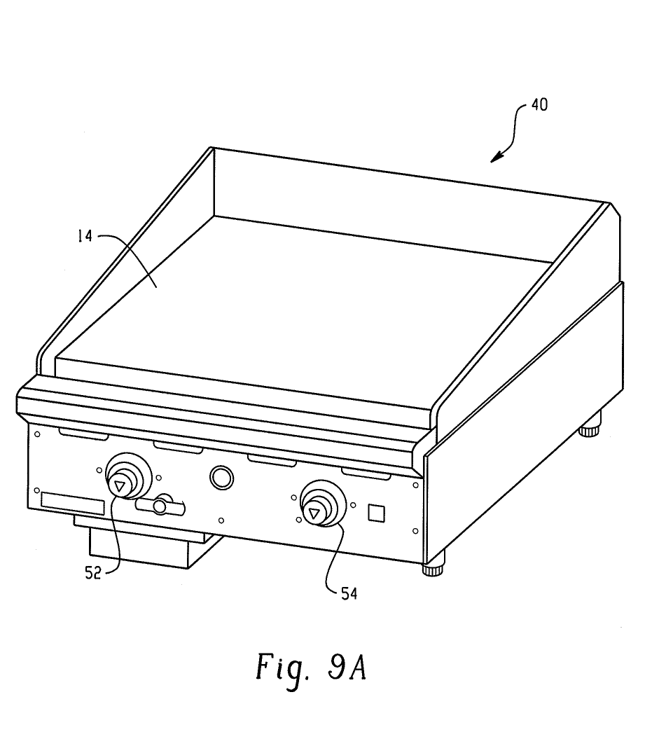

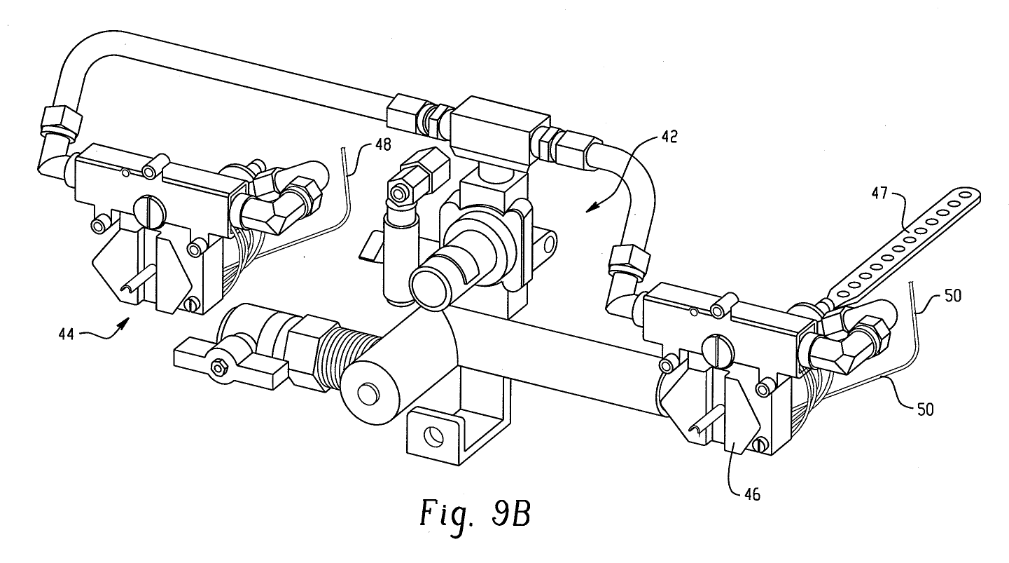

Referring now to FIGS. 9A and 9B, an exemplary griddle apparatus 40 is shown along with and exemplary gas feed system 42 (that is located within the unit). Thermostatic valves 44 and 46, each of which controls gas flow to a respective burner (e.g., 47), include respective lines 48 and 50 running to respective thermostat bulbs (e.g., bulb 18 of FIG. 3). The thermostat valves act as heating element controls based upon the temperature feedback from the respective thermostat bulbs. The ON/OFF (or OPEN/CLOSE) temperature setpoint of each valve 44, 46 is adjustable manually via a user control knob 52, 54.

It is to be clearly understood that the above description is intended by way of illustration and example only and is not intended to be taken by way of limitation, and that changes and modifications are possible. For example, while a griddle apparatus is primarily described, the inventive concepts could be utilized in connection with other cooking plate devices, such as braising pans. Moreover, although a griddle plate with an upwardly facing cooking surface is primarily shown and described, the shielding arrangements could be implemented on a top griddle plate (e.g., the upper griddle plate of a clamshell type griddle 70 having both an upper griddle plate 72 and a lower griddle plate 74 per the schematic of FIG. 9, where the cooking surface of upper plate 72 faces downward when in the cooking position). Accordingly, other embodiments are contemplated and modifications and changes could be made without departing from the scope of this application.

What is claimed is:

1. A cooking apparatus, comprising:
a housing;
a heating element located in the housing;
a cooking plate arranged and configured to be heated by the heating element, the cooking plate having a first surface facing the heating element and a cooking surface opposite the first surface;
a thermostat proximate the first surface and associated with a heating element control;
an insulating heat shield arrangement partially surrounding the thermostat and shielding a shielded portion of the first surface adjacent the thermostat from direct heating by the heating element, the insulating heat shield arrangement configured to provide a thermal resistance Rₕ through the cooking plate between the shielded portion of the first surface at the thermostat and a directly heated portion of the first surface outside the shielded portion;
the cooking plate configured such that a thermal resistance R_{c} through the cooking plate is provided between the shielded portion of the first surface at the thermostat and the cooking surface;
wherein the insulating heat shield arrangement is configured such that the thermal resistance Rₕ is no less than the thermal resistance R_{c}.

2. The cooking apparatus of claim 1 wherein the cooking surface of the cooking plate is either an upwardly facing surface or a downwardly facing surface.

3. The cooking apparatus of claim 1 wherein the insulating heat shield arrangement includes a first heat shield and an adjacent insulating material.

4. The cooking apparatus of claim 3 wherein the first heat shield is located proximate the thermostat and the insulating material is located to an external side of the first heat shield.

5. The cooking apparatus of claim 4 wherein the insulating heat shield arrangement includes a second heat shield disposed at an external side of the insulating material.

6. The cooking apparatus of claim 1 wherein the insulating heat shield arrangement is configured such that the thermal resistance Rₕ is at least 105% of the thermal resistance R_{c}.

7. The cooking apparatus of claim 2 wherein the insulating heat shield arrangement is configured such that the thermal resistance Rₕ is at least 110% of the thermal resistance R_{c}.

8. The cooking apparatus of claim 1 wherein the first surface is substantially planar and the thermostat is positioned in contact with the first surface.

9. The cooking apparatus of claim 1 wherein the first surface includes a recessed portion, the thermostat is positioned in contact with the cooking plate in the recessed portion.

10. The cooking apparatus of claim 1 wherein the cooking plate is formed of a substantially uniform material.

11. The cooking apparatus of claim 1 wherein the cooking plate is of a laminated configuration using at least two different materials.

12. A cooking apparatus, comprising:
a heating element;
a cooking plate arranged and configured to be heated by the heating element, the cooking plate having a first surface facing the heating element and a cooking surface opposite the first surface;
a temperature sensor proximate the first surface and associated with a heating element control;
an insulating heat shield arrangement partially surrounding the temperature sensor and shielding a shielded portion of the first surface adjacent the thermostat from direct heating by the heating element, the insulating heat shield arrangement configured to provide a through the plate thermal resistance Rₕ between the shielded portion of the first surface at the temperature sensor and a directly heated portion of the first surface outside the shielded portion;
the cooking plate configured such that a through the plate thermal resistance R_{c} is provided between the shielded portion of the first surface at the temperature sensor and the cooking surface;
wherein the insulating heat shield arrangement is configured such that the through the plate thermal resistance Rₕ is at least about 90% of the through the plate thermal resistance R_{c}.

13. The cooking apparatus of claim 12 where the through the plate thermal resistance Rₕ is leas than about 135% of the through the plate thermal resistance R_{c}.

14. The cooking apparatus of claim 13 wherein the through the plate thermal resistance Rₕ is between about 95% and 125% of the through the plate thermal resistance R_{c}.

15. The cooking apparatus of claim 12 wherein the cooking plate is formed of a substantially uniform material having substantially the same thermal resistance per unit length through the material regardless of direction, and a lateral distance between the shielded portion of the first surface at the temperature sensor and the directly heated portion of the first surface outside the shielded portion is no less than a vertical distance between the first surface and the cooking surface.

16. A method of designing a cooking plate configuration for a cooking apparatus, the method comprising the steps of:
determining a location for a thermostat element along a heated surface of the cooking plate;
determining a through the plate thermal resistance R_{c} between a cooking surface of the cooking plate and the defined location of the thermostat element;
determining a lateral distance from the thermostat element that results in a lateral through the plate thermal resistance Rₕ that is at least about 90% of the through the plate thermal resistance R_{c}; and
defining a heat shield configuration that corresponds to the determined lateral distance.

17. The method of claim 16 wherein the lateral distance determining step is performed such that the resulting through the plate thermal resistance Rₕ is at least as great as the through the plate thermal resistance R_{c}.

18. The method of claim 16 wherein the lateral distance determining step is performed such that the resulting through the plate thermal resistance Rₕ is no more than 135% of the through the plate thermal resistance R_{c}.
